(19) United States
(12) Patent Application Publication
(10) Pub. No.: US 2022/0402705 A1
(43) Pub. Date: Dec. 22, 2022

(54) WORKPIECE TRANSFER METHOD AND WORKPIECE TRANSFER SYSTEM

(71) Applicant: TSUBAKIMOTO CHAIN CO., Osaka (JP)

(72) Inventor: Tomokatsu TAKAHASHI, Osaka (JP)

(73) Assignee: TSUBAKIMOTO CHAIN CO., Osaka (JP)

(21) Appl. No.: 17/895,167

(22) Filed: Aug. 25, 2022

Related U.S. Application Data
(63) Continuation of application No. PCT/JP2020/045656, filed on Dec. 8, 2020.

(30) Foreign Application Priority Data
Mar. 18, 2020 (JP) 2020-047212

(51) Int. Cl. B65G 47/90

(52) U.S. Cl. CPC B65G 47/90

(57) ABSTRACT

The present invention aims at providing a workpiece transfer method and a workpiece transfer system that enable stable transfer of workpieces with a simple structure. The workpiece transfer system includes two workpiece holding members that hold workpieces such as to be inserted and pulled out in a vertical direction, a picking device having a claw member operable to open and close, and a temporary workpiece holding member. The workpiece transfer method includes: grasping and transferring a workpiece that is held by one workpiece holding member to a temporary workpiece holding member, and transferring the workpiece from the temporary workpiece holding member to another workpiece holding member after the workpiece has been grasped again at a point where the workpiece is held in a stable posture.

### BACKGROUND OF THE INVENTION

### 1. Field of the Invention

The present invention relates to a workpiece transfer method and a workpiece transfer system suitable for transfer of a target workpiece from a tray for applications where workpieces such as vials or microtubes containing samples or chemicals for drug development research are accommodated on trays and stored in freezing environments, for example.

### 2. Description of the Related Art

A multiplicity of samples such as biological or clinical samples or chemical compounds are stored for examination or other purposes in modern basic and applied research in the fields of chemistry, biochemistry, somatology, and pharmaceutical sciences.

For example, in a research process of drug development, it is necessary to handle a multiplicity of small amounts of samples for a variety of tests and experiments in order to investigate biological activities or the like. Essential in the process are the techniques that enable storage of a large number of samples in containers such as microtubes in a stable, very low-temperature environment, as well as speedy pick-up of a given sample.

Automation has been achieved in such a system by a picking device that takes out a small workpiece such as a microtube from a storage tray and transfers the workpiece from a transport tray to a storage tray.

Japanese Patent Application Publication No. 2008-093767, for example, discloses a picking device having a plurality of claw members operable to open and close by an open/close means, to grip a workpiece on its sides, pull it up by a lifting means, and place the workpiece to a predetermined location.

In a drug development research process in general, microtubes are vertically accommodated, i.e., held upright, in a storage rack having 96 wells in an 8×12 format (96 tube rack), for example, for storage and transport.

For higher density storage, recent years have seen the use of storage racks having 16 rows and 24 columns, i.e., a total of 384 wells, with an outer shape having the same size as the 96 tube racks according to the SBS (Society for Biomolecular Screening) standards. Correspondingly, the size of microtubes themselves has become smaller to be more suited to the storage of small amounts of samples.

### SUMMARY OF THE INVENTION

The decrease in workpiece size and the increase in storage density mean a reduced space between adjacent workpieces for the claw members of the picking device to enter. In the case with a microtube, for example, the point where the workpiece can be grasped is limited to its cap. The difficulty in grasping the workpiece stably causes the problem of compromised precision in picking.

The present invention solves this problem and aims at providing a workpiece transfer method and a workpiece transfer system that enable stable transfer of workpieces with a simple structure.

The present invention solves the above problem by providing a workpiece transfer method for transferring a workpiece between two workpiece holding members by use of a picking device having a claw member operable to open and close to grasp the workpiece, the method including: transferring a workpiece that is held by one workpiece holding member such as to allow the workpiece to be inserted and pulled out in a vertical direction to a temporary workpiece holding member; and transferring the workpiece from the temporary workpiece holding member to another workpiece holding member after the workpiece has been grasped again at a point where the workpiece is held in a stable posture.

The present invention solves the above problem by providing a workpiece transfer system for transferring a workpiece, including: two workpiece holding members that hold workpieces such as to be inserted and pulled out in a vertical direction; a picking device having a claw member operable to open and close, for grasping a workpiece with the claw member and transferring the workpiece from one to another of the workpiece holding members; and a temporary workpiece holding member used for placing a workpiece to grasp the workpiece again at a point where the workpiece is held in a stable posture when transferring the workpiece from one workpiece holding member to another workpiece holding member.

According to the workpiece transfer method set forth in claim 1 and the workpiece transfer system set forth in claim 5 with which the workpiece transfer method is executed, the workpiece can be grasped in a stable posture by once transferring the workpiece to a temporary workpiece holding member to grasp it again at a different point. For transfer of workpieces held on one workpiece holding member to another, the system only needs to be able to grasp a target workpiece alone. Thus stable transfer of workpieces onto another workpiece holding member can be achieved with a simple structure.

According to the configuration set forth in claim 2 and the configuration set forth in claim 6, any workpieces being transferred from one workpiece holding member to the temporary workpiece holding member in an unstable posture can be held in the workpiece holding part of the temporary workpiece holding member.

According to the configuration set forth in claim 3 and the configuration set forth in claim 7, the force by which the workpiece is grasped by the claw member is weakened so that the posture of the workpiece can be corrected by the effect of the tapered surface of the guide part. The workpiece can thus reliably be held in the workpiece holding part of the temporary workpiece holding member.

According to the configuration set forth in claim 4 and the configuration set forth in claim 8, a simple operation of lowering the claw member enables the grasping of the workpiece in a stable posture.

### BRIEF DESCRIPTION OF THE DRAWINGS

FIG. 1 is a schematic perspective view illustrating a configuration example of a workpiece transfer system according to the present invention;

FIG. 2 is a longitudinal cross-sectional view illustrating a configuration example of a picking device;

FIG. 3 is a longitudinal cross-sectional view of a temporary workpiece holding member along a center axis of its workpiece holding part;

FIG. 4 is an illustrative diagram for explaining a first transfer operation of transferring a workpiece from one workpiece holding member to the temporary workpiece holding member in the workpiece transfer system of the present invention; and

FIG. 5 is an illustrative diagram for explaining a second transfer operation of transferring a workpiece from the temporary workpiece holding member to another workpiece holding member in the workpiece transfer system of the present invention.

### DESCRIPTION OF THE PREFERRED EMBODIMENT

A workpiece transfer method and a workpiece transfer system according to the present invention are described below with reference to the drawings.

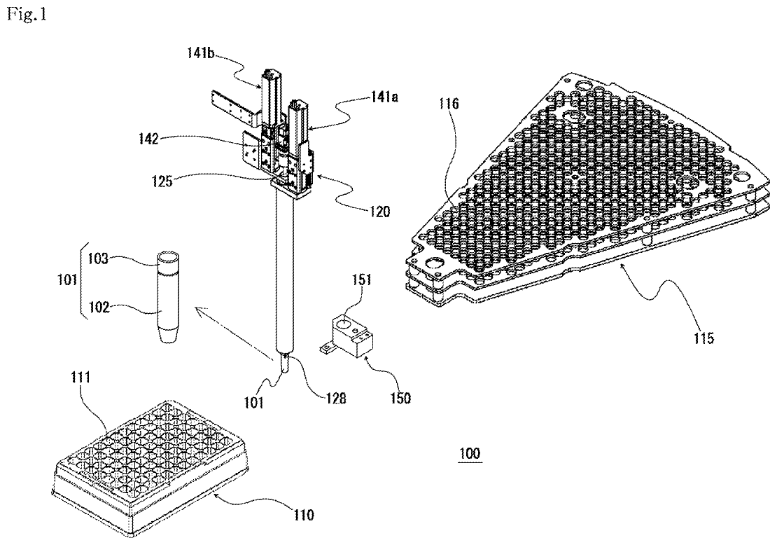

FIG. 1 is a schematic perspective view illustrating a configuration example of a workpiece transfer system according to the present invention.

The workpiece transfer system 100 of this embodiment includes two workpiece holding members that hold workpieces, which are for example microtubes 101 that are storage objects to be stored in a low-temperature environment in a low-temperature storage system, such as to allow the workpieces to be inserted and pulled out in a vertical direction, and a picking device 120 having claw members 128 operable to open and close, for grasping microtubes 101 with the claw members 128 and transferring them from one to another of workpiece holding members. The microtube 101 is a cylindrical container, for example, and includes a tube body 102, and a cap 103 removably attached to the tube body 102. The workpiece may be other containers than microtubes, such as vials, for example.

While a rack 110 and a tray 115 are shown as workpiece holding members for transporting or storing microtubes 101 in this embodiment, the manner in which microtubes 101 are held (or stored) is not limited to this example. Microtubes 101 may be transferred from one to another of two racks, for example.

The rack 110 is configured with a plurality of workpiece holding parts 111 arrayed in a grid pattern, which hold microtubes 101 such as to allow them to be vertically inserted and pulled out in a posture in which their tube axis extends along the vertical direction.

The tray 115 is to be placed in a storage region on a disc-like stage that is a shelf set inside a low-temperature storage chamber of the low-temperature storage system, for example, and has a fan-like shape in plan view. The tray has a multiplicity of workpiece holding parts 116, which hold microtubes 101 such as to allow them to be vertically inserted and pulled out in a posture in which their tube axis extends along the vertical direction.

The picking device 120 approaches a predetermined microtube 101 that is selected from a multiplicity of microtubes 101 held on one workpiece holding member from above, while positioning the claw members 128 to the microtube 101, picks up the microtube 101 with the claw members 128, and transfers it onto another workpiece holding member. The transfer operation may be performed such as to move a microtube 101 from the rack 110 to the tray 115, or from the tray 115 to the rack 110. FIG. 1 shows the rack 110 and tray 115 not holding any microtubes 101.

The picking device 120 has four equally spaced claw members 128, for example, which grasp a microtube 101 by contact with side faces of the microtube 101, and is configured to be freely movable in three directions including directions within a horizontal plane and a direction perpendicular thereto by way of moving means (not shown).

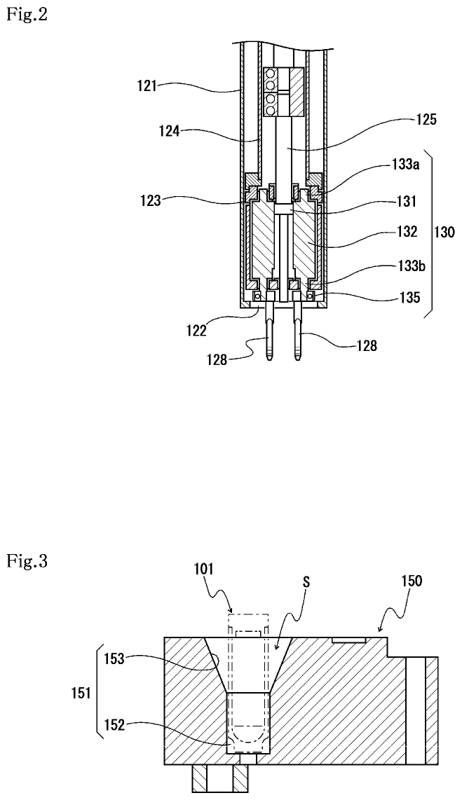

To be more specific, the picking device 120 is configured, as shown in FIG. 2, to include a cylindrical outer cover member 121 extending along the vertical direction and closed at the bottom with a wall, a holder 123 disposed inside the outer cover member 121 closer to the bottom wall and including a sleeve part 124 extending in the vertical direction and coaxial with the outer cover member 121, a center shaft member 125 passed through the sleeve part 124 of the holder 123, and a claw open/close means 130.

The outer cover member 121 is disposed such as to be movable up and down relative to the center shaft member 125 by use of an actuator 141a.

In the bottom wall of the outer cover member 121 is formed a claw passage hole 122 in such a shape that the cap 103 of the microtube 101 can pass through and the claw members 128 can open and close without being hindered. The outer cover member 121 has such a shape that it makes contact with adjacent microtubes 101 around the microtube 101 to be picked up. When holding a target microtube 101, the outer cover member 121 is extended relative to the claw members 128 so as to ensure separation from other microtubes 101 adjoining the target microtube 101.

The holder 123 supports four driven gears, which are parts of the claw open/close means to be described later, such as to be rotatable around vertically extending axes. The holder is disposed such as to be movable up and down by an actuator 141b relative to the center shaft member 125.

The center shaft member 125 is disposed inside the sleeve part 124 of the holder 123 and coaxial with the sleeve part 124, and is configured to be rotatable around a vertically extending axis by a drive motor 142.

The center shaft member 125 moves up the holder 123 to retract the claw members 128 when releasing a microtube 101 that is being held, to ensure separation of the microtube 101.

The claw open/close means 130 is made up of a drive gear 131 provided to the center shaft member 125, four driven gears 132 with vertically extending pivot shafts 133a and 133b at both ends rotatably supported by the holder 123, and four plate-like pivot arms 135 fixed to the pivot shafts 133b of the driven gears 132.

The claw members 128 are vertically oriented and fixed to the pivot arms 135 at points offset from the rotation center axes of the driven gears 132.

Each of the driven gears 132 is configured to mesh with the drive gear 131, so that when the center shaft member 125 is rotated, the four driven gears 132 rotate (around their axes). This causes the four pivot arms 135 to pivot and allows the four claw members 128 to open and close simultaneously.

The driven gears 132 have an axial length corresponding to a reciprocating stroke of the holder 123 so that the driven gears 132 can mesh with the drive gear 131 wherever the holder 123 may be located in the reciprocating directions.

The claw members 128 and pivot arms 135, and the center shaft member 125 and drive gear 131, may be formed integrally, or may be separate parts joined firmly together.

The workpiece transfer system 100 described above includes a temporary workpiece holding member 150, which is used for placing a microtube 101 to grasp it again in a more stable posture when transferring a microtube 101 held on one workpiece holding member to another workpiece holding member.

The temporary workpiece holding member 150 has a workpiece holding part 151 that is open upwards and holds a microtube 101 in a posture with its center axis extending vertically such as to allow it to be inserted and pulled out in the vertical direction as shown in FIG. 3.

The workpiece holding part 151 includes a receptacle/support part 152 formed as a columnar space for receiving and holding a lower end part of the tube body 102 of the microtube 101, and a guide part 153 formed as a truncated conical space for guiding the microtube 101 inward.

The guide part 153 is configured to leave an upper end part of the tube body 102 of the microtube 101 exposed. Therefore, when a microtube 101 is held, there is a space S between the circumferential surface of the microtube 101 and the tapered inner circumferential surface of the guide part 153 for the claw members 128 to enter.

The operation of the workpiece transfer system 100 configured as described above will be explained.

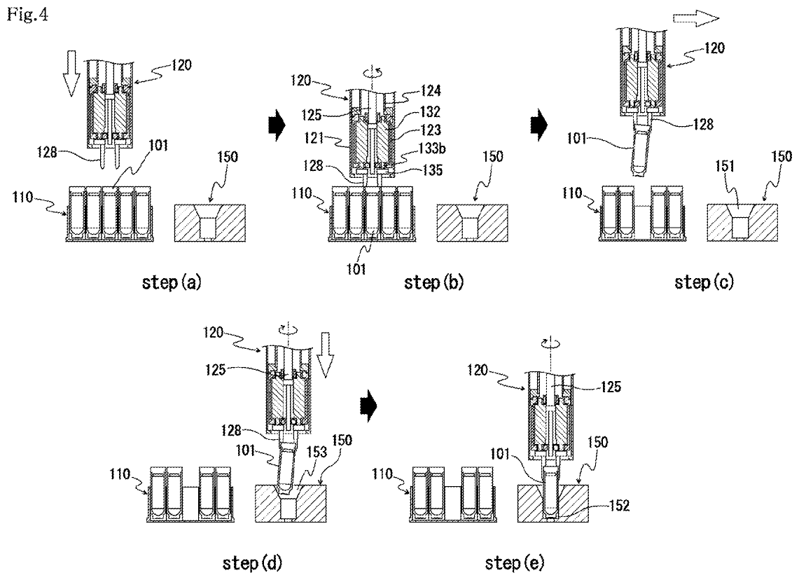

In the workpiece transfer system 100 according to this embodiment, microtubes 101 are once moved from a rack 110 that is one workpiece holding member to the temporary workpiece holding member 150, and successively transferred from the temporary workpiece holding member 150 to a tray 115 that is another workpiece holding member. Below, the first transfer operation of transferring a microtube 101 from the rack 110 to the temporary workpiece holding member 150 will be described first with reference to FIG. 4. FIG. 4 illustrates the rack 110 in a simplified form.

In the first transfer operation, the picking device 120 is positioned relative to the rack 110 that is holding a multiplicity of microtubes at a point where the picking device is able to grasp a microtube 101 that is to be picked up, after which the entire picking device 120 is lowered (step (a)). In FIG. 4, the moving direction of the picking device 120 is indicated with a white arrow.

When the picking device 120 is lowered toward the microtube 101 to be picked up and the four claw members 128 are inserted next to the microtube 101, the center shaft member 125 is rotated so that the claw members 128 grasp the microtube 101. Namely, the rotation of the center shaft member 125 rotates each of the four driven gears 132. This causes the pivot arms 135 fixed to the pivot shafts 133b of the driven gears 132 to pivot so that the claw members 128 move toward the microtube 101 and grasp the sides of the cap 103 of the microtube 101 (step (b)).

Once the microtube 101 to be picked up is grasped by the claw members 128, the entire picking device 120 is lifted up to bring the picked-up microtube 101 completely above the rack (step (c)).

Next, the entire picking device 120 is moved horizontally to move the microtube 101 grasped by the claw members 128 to a position directly above the workpiece holding part 151 of the temporary workpiece holding member 150.

Once the microtube 101 is positioned directly above the workpiece holding part 151 of the temporary workpiece holding member 150, the entire picking device 120 is lowered.

As the microtube 101 comes down to a suitable position, the center shaft member 125 is rotated to weaken the force by which the microtube 101 is grasped by the claw members 128. In this state, the entire picking device 120 is further lowered. For a microtube 101 that is being grasped in an unstable posture, the tapered surface of the guide part 153 of the temporary workpiece holding member 150 provides a guide so that the microtube 101 is adjusted to a correct posture (step (d)).

Once the tube body 102 of the microtube 101 is inserted into the receptacle/support part 152 of the temporary workpiece holding member 150, the center shaft member 125 is rotated. This causes the claw members 128 to open up to release the microtube 101, which completes the first transfer operation of the microtube 101 from the rack 110 to the temporary workpiece holding member 150 (step (e)).

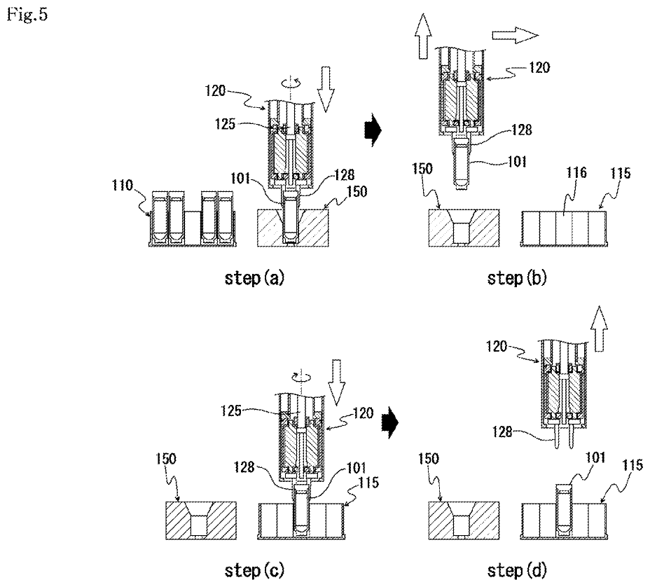

Next, the second transfer operation of transferring the microtube 101 from the temporary workpiece holding member 150 to a tray 115 will be described with reference to FIG. 5. FIG. 5 illustrates the tray 115 in a simplified form.

In the second transfer operation, the entire picking device 120 is lowered from the vertical position where the microtube 101 was released to allow the claw members 128 to change the microtube gripping position to such a point where the microtube 101 can be held in a stable posture. In this state, the center shaft member 125 is rotated so that the claw members 128 grasp the sides of the tube body 102 of the microtube 101 (step (a)). In FIG. 5, the moving direction of the picking device 120 is indicated with a white arrow.

After the microtube 101 has been grasped again, the entire picking device 120 is lifted up to bring the microtube 101 completely above the temporary workpiece holding member 150 (step (b)).

Next, the entire picking device 120 is moved horizontally to move the microtube 101 grasped by the claw members 128 to a position directly above a predetermined workpiece holding part 116 of the tray 115.

Once the microtube 101 is positioned directly above the predetermined workpiece holding part 116 of the tray 115, the entire picking device 120 is lowered.

As the microtube 101 comes down to a suitable position, the center shaft member 125 is rotated to open up the claw members 128 so that the microtube 101 is released (step (c)).

Next, the entire picking device 120 is lifted up. The picking device 120 being lifted up completely marks the completion of the second transfer operation of the microtube 101 from the temporary workpiece holding member 150 to the tray 115 (step (d)).

Thus the operation of transferring one microtube 101 from a rack 110 to a tray 115 is complete, and the next operation follows.

While one embodiment of the present invention has been described in detail, the present invention is not limited to the embodiment described above and may be carried out with various design changes without departing from the scope of the present invention set forth in the claims.

The workpiece transfer system according to the present invention is applicable not only to transfer of microtubes or vials containing samples or chemicals for drug creation research but also to transfer of workpieces in various assembling machines and machine tools.

The configuration of the temporary workpiece holding member is not limited to the one in the above embodiment. Other configurations that allow the claw members to change the workpiece gripping position from that of the first transfer operation to a point vertically lower than that can be adopted.

The picking device is not limited to the one described in the above embodiment. The claw open/close means may be configured with a planetary gear mechanism, or other mechanisms using an electric actuator or electromagnetic solenoid.

Three or five or more claw members may be used instead of four as described in the above embodiment, and not all the claw members need be operable to open and close. The claw members need not necessarily be circumferentially equally spaced. While the claw members in the illustrated example are straight and columnar, they may have other cross-sectional shapes, or bent, or hollow. Parts of the claw members that contact the workpieces may be textured, or provided with a cushioning member. Claw members of different shapes and/or materials may be used in combination.

What is claimed is:

1. A workpiece transfer method for transferring a workpiece between two workpiece holding members by use of a picking device having a claw member operable to open and close to grasp the workpiece, the method comprising:
transferring a workpiece that is held by one workpiece holding member such as to allow the workpiece to be inserted and pulled out in a vertical direction to a temporary workpiece holding member; and
transferring the workpiece from the temporary workpiece holding member to another workpiece holding member after the workpiece has been grasped again at a point where the workpiece is held in a stable posture.

2. The workpiece transfer method according to claim 1, wherein the temporary workpiece holding member includes a workpiece holding part open upwards and capable of holding the workpiece such as to be inserted and pulled out in a vertical direction, the workpiece holding part including a guide part that is wider upwards to lead the workpiece thereinto.

3. The workpiece transfer method according to claim 2, wherein the claw member weakens a force whereby the workpiece is grasped when the workpiece is inserted into a workpiece holding part of the temporary workpiece holding member.

4. The workpiece transfer method according to claim 2, wherein, when transferring the workpiece from the temporary workpiece holding member to another workpiece holding member, the claw member is inserted into a space formed between a side face of the workpiece and an inner face of the guide part, to grasp the workpiece again at a point lower than a position at which the workpiece was held when being transferred from the one workpiece holding member to the temporary workpiece holding member.

5. A workpiece transfer system for transferring a workpiece, comprising:
two workpiece holding members that hold workpieces such as to be inserted and pulled out in a vertical direction;
a picking device having a claw member operable to open and close, for grasping a workpiece with the claw member and transferring the workpiece from one to another of the workpiece holding members; and
a temporary workpiece holding member used for placing a workpiece to grasp the workpiece again at a point where the workpiece is held in a stable posture when transferring the workpiece from one workpiece holding member to another workpiece holding member.

6. The workpiece transfer system according to claim 6, wherein the temporary workpiece holding member includes a workpiece holding part open upwards and capable of holding the workpiece such as to be inserted and pulled out in a vertical direction,
the workpiece holding part including a guide part that is wider upwards to lead the workpiece thereinto.

7. The workpiece transfer system according to claim 6, wherein the picking device includes a claw open/close means operable to weaken a force whereby the workpiece is grasped when the workpiece is inserted into a workpiece holding part of the temporary workpiece holding member.

8. The workpiece transfer system according to claim 6, wherein the guide part is configured to form a space between a side face of a workpiece and an inner face of the guide part for the claw member to enter.
